(19) United States
(12) Patent Application Publication
(10) Pub. No.: US 2026/0214199 A1
(43) Pub. Date: Jul. 23, 2026

(54) MULTISPECTRAL IMAGING INTEGRATED SYSTEM AND DEVICE AND USING METHOD THEREOF

(71) Applicant: Zibo Haishi Dan Biotechnology Co., LTD, Zibo (CN)

(72) Inventor: Yaqi LI, Zibo (CN)

(73) Assignee: Zibo Haishi Dan Biotechnology Co., LTD, Zibo (CN)

(21) Appl. No.: 19/035,766

(22) Filed: Jan. 23, 2025

(30) Foreign Application Priority Data
Nov. 27, 2023 (CN) 202311596104.9

(51) Int. Cl. H04N 17/00; G01N 21/31; G06T 7/80; H04N 23/56

(52) U.S. Cl. CPC H04N 17/002; G01N 21/31; G06T 7/80; H04N 23/56; G01N 2201/062; G01N 2201/127; G06T 2207/10152

(57) ABSTRACT

A multispectral imaging integrated system and device and using method thereof are provided. The device includes an imaging unit, a combination of feature illuminant sources, a data storage unit, a data processing unit and a display/control unit. The combination of feature illuminant sources adopts N (N≥2) linearly independent illuminant sources. Spectrum of the illuminant sources are calibrated on M (M≥2) adjacent wavebands, and calibrated data are stored on the device. In use, the device acquires N images of a tested sample under different feature illuminant sources by the imaging unit, and simultaneously acquires optical reflectance or transmittance images of the sample in M (M≥2) adjacent wavebands within a specific wavelength range based on illuminant source calibration data and related calculation. The present technology has broad utility in a field of biochemical analysis.

### CROSS-REFERENCE TO RELATED APPLICATIONS

This patent application claims the benefit and priority of Chinese Patent Application No. 202311596104.9, entitled “MULTISPECTRAL IMAGING INTEGRATED SYSTEM AND DEVICE AND USING METHOD THEREOF” filed with the China National Intellectual Property Administration on Nov. 27, 2023, the disclosure of which is incorporated by reference herein in its entirety as part of the present application.

### TECHNICAL FIELD

The present disclosure relates to the field of biochemical analysis technology, specifically a multispectral imaging integrated system and a device and a using method thereof.

### BACKGROUND

A digital imaging device generates a digital image of a photographed subject under a certain illumination condition by using an optical system and an image sensor. Pixels of the image provide brightness data for each point of the photographed subject under specific illumination conditions. A color imaging device uses color filter array technology to provide brightness data under three optical filters, i.e. red, green and blue optical filters. These data contain spectral information of the photographed subject, by which the color of the photographed subject can be distinguished and determined. A multispectral imaging device differs from a general imaging device in that it provides more spectral information about the photographed subject, i.e. the brightness data of the photographed subject in more spectral wavebands. The brightness data of the image are integration results of the spectrum of a shooting illuminant source, the sensitivity curve of the image sensor, and the reflection/transmission spectrum of the photographed subject within a certain wavelength range. When the spectrum of the illuminant source and the curve of the sensor are determined, features of the reflection/transmission spectrum of the photographed subject can be obtained from the multispectral image data.

The substance has certain spectral features for reflection and absorption of light, and therefore the multispectral imaging device has many applications in fields related to the distinguishing of substances or observation of changes in substances. For example, aircraft and satellites observe geological, vegetation and agricultural plant changes using the multispectral imaging device to collect data about deforestation, ecosystem degradation and climate change. In the food safety field, the multispectral imaging device is used to monitor storage state and freshness of fruits and food products; in the field of medical diagnosis, the multispectral imaging device is used to distinguish different cell tissues and lesions; and in the field of art, the multispectral imaging device is used to identify and accurately digitize and save artworks.

The existing multispectral imaging device generally uses a filter splitting principle. There is a device in which multiple independent cameras are integrated, with different optical filters arranged on lens of each camera. These cameras synchronously shoot images of a test object in different spectral wavebands. The disadvantage of this device is that parallax exists between different lenses, and a certain error may be generated when data of cameras are fused into spectral data. There is a device, in which a filter rotating disc is arranged in front of a camera lens, and images of different wavebands are obtained by changing the filter during shooting. The disadvantage of this device is that a component needs to be rotated mechanically, and the shooting takes a relatively long time. There is also a “multispectral filter array” technical solution, in which more optical filters are directly configured on the image sensor. This solution has certain technical challenges in manufacturing, and decreases the spatial resolution of an image while increasing a waveband.

There is another type of spectral imaging device using the grating or prism splitting principle. Such device obtains a high-resolution spectral image by means of built-in scanning, and is generally referred to as a “high-spectral imaging” or “hyper-spectral imaging” device. And such device differs from the multispectral imaging device in application.

For example, in the field of colorimetric analysis, a large number of environments and healthy detections now use the principle of colorimetric analysis, and a biochemical analyzer is required to perform quantitative or qualitative analysis. Currently, the biochemical analyzer is used to sequentially test a single sample.

Currently, some technical solutions use a color digital camera to perform colorimetric analysis. But these technical solutions have fundamental problems in test principle. For example, the theoretical basis of the colorimetric analysis is Lambert-Beer's law, which describes the relationship between the optical absorption intensity of a substance at a specific wavelength and the concentration of an optical absorbing substance and the thickness of a liquid layer thereof. Colorimetric analysis is essentially not a method for comparing or measuring color, but rather a method for measuring the optical absorption intensity of an identified substance at a particular wavelength to determine the concentration of a measured substance. The biochemical analyzers calculate the concentration of the measured substance by measuring the optical absorbance of a sample at a particular wavelength range. However, color data generated by a common digital camera is a comprehensive numerical value of an illumination spectrum, a spectral curve of a color filter, a sensitivity curve of a sensor, and an absorption spectrum of a sample in a very wide wavelength range, and has no definite relationship with the optical absorbance of the sample in a particular wavelength range. Accordingly, data of an ordinary digital camera is not applicable to the Lambert-Beer's law, resulting in insufficient accuracy and precision of a detection result, and a large error.

### SUMMARY

The present disclosure provides a multi-spectra test principle and a technical solution with a simple structure, easy implementation and high cost performance by replacing optical elements such as a filter used in the conventional art with a mathematical model and an algorithm. Using a calibrated group of feature illuminant sources and a general digital imaging unit, a device of the present disclosure simultaneously generates a reflectance or transmittance spectral image of a sample on a series of adjacent wavebands, and directly displays an overall spectral feature of any point of a test object within a testing spectral range, thereby fundamentally solving the technical principle problem faced when using a color digital imaging machine for colorimetric analysis. The present disclosure can simultaneously perform biochemical quantitative analysis in a real sense on a large quantity of colorimetric/nephelometric samples, and has significant value for improving the efficiency of biochemical analysis and popularizing biochemical analysis to the public.

In order to achieve the above effects, the present disclosure provides the following technical solutions: a multispectral imaging unit provided in the present disclosure includes an imaging unit, a combination of feature illuminant sources, a data storage unit, a data processing unit and a display/control unit;
wherein the combination of feature illuminant sources comprises N (N≥2) linearly independent illuminant sources within a predetermined range of test spectrum, and spectral widths of the illuminant sources are not restricted;
wherein the feature illuminant sources are calibrated on a plurality of adjacent wavebands; calibrated data are stored in the data storage unit of the device; the imaging unit is configured to generate a plurality of images of a tested sample under illumination of different feature illuminant sources; and the data processing unit and the data storage unit are configured to analyze and calculate the plurality of images of the sample based on a illuminant characterization matrix and associated algorithms to obtain an optical reflectance or transmittance spectral image of the sample in a specific wavelength range, simultaneously.

In an embodiment, the algorithm includes:
1) calibrating the feature illuminant sources; wherein the predetermined range of test spectrum is divided into M (M≥2) adjacent wavebands, and spectral features of the N (N≥2) illuminant sources are calibrated into an M×N illuminant characterization matrix stored in the data storage unit;
2) testing to obtain images of a test object; wherein in a space shielded from external light, the feature illuminant sources in step 1) are used respectively to illuminate a tested sample in an individual or combined manner, and N images of the tested sample are obtained under illumination of different illuminant sources by the imaging unit; and
3) analyzing and calculating to obtain average optical reflectance values or transmittance values at any point of the tested sample; wherein based on brightness data of N images, the average optical reflectance values or transmittance values at any point of the test object on M adjacent wavebands is obtained simultaneously by means of the illuminant characterization matrix and associated calculations, and the reflectance values or transmittance values on a series of adjacent wavebands directly reveal an overall spectral feature of the test object on a test range.

In an embodiment, the illuminant sources adopt calibrated illuminant sources, the feature illuminant sources adopt LED illuminant sources with different central wavelengths, and spectrum of any one of the feature illuminant sources cannot be obtained by a linear combination of other illuminant sources;
spectral features of the feature illuminant sources are calibrated into the illuminant characterization matrix, and the combination of illuminant sources comprises N feature illuminant sources; wherein the calibration method is as follows:
dividing the predetermined range of test spectrum into N adjacent wavebands, wherein each waveband occupies a range of wavelengths from λⱼ₋₁ to λⱼ (λⱼ>λⱼ₋₁, j=1, 2, . . . , N), and the width of each waveband is not restricted;
taking the following formula to express an average intensity of the i-th illuminant source on the j-th waveband:

$${I}_{ij} = \frac{1}{{λ}_{j} - {λ}_{j - 1}} \cdot {\int }_{{λ}_{j - 1}}^{{λ}_{j}} {I}_{i} ( λ ) d λ , i = 1 , 2 , ⋯ , N , j = 1 , 2 , ⋯ , N \qquad ( 1 )$$

wherein Iᵢ(λ) is an intensity of the i-th illuminant source at wavelength A measured by an external spectroscopic tester;

performing above calculation on N wavebands and N illuminant sources to form an N×N matrix [symbol] ,

$$\overleftrightarrow{I} = [ \begin{matrix}{I}_{11} & ⋯ & {I}_{1 N} \\ ⋮ & ⋱ & ⋮ \\ {I}_{N 1} & ⋯ & {I}_{NN}\end{matrix} ] \qquad ( 2 )$$

wherein the matrix [symbol] represents average intensities on N wavebands for each of the feature illuminant sources, respectively, wherein matrix inverse calculation is performed on the matrix [symbol] to obtain an N×N matrix referred to as a illuminant characterization matrix, and wherein the illuminant characterization matrix is represented as:

$$\overleftrightarrow{J} = {\overleftrightarrow{I}}^{- 1} = [ \begin{matrix}{J}_{11} & ⋯ & {J}_{1 N} \\ ⋮ & ⋱ & ⋮ \\ {J}_{N 1} & ⋯ & {J}_{NN}\end{matrix} ] \qquad ( 3 )$$

wherein the obtained illuminant characterization matrix [symbol] is stored in the data storage unit.

In an embodiment, before testing the sample, brightness data of a black or standard non-transparent sample and a white or standard transparent sample are tested as reference values for calculating the reflectance values or transmittance values;
a method for acquiring black standard data and white standard data is as follows:
placing a black standard sample at a location where the sample is placed, acquiring N images of black standard luminance under illumination of N feature illuminant sources respectively in a manner of testing a common sample; then testing a white standard sample in the same manner to obtain N images of white standard luminance under the illumination of N feature illuminant sources; wherein after testing the black standard sample and white standard sample, any pixel p of a multispectral image has a black standard value and a white standard value corresponding to each feature illuminant source, wherein the black standard value and the white standard value are represented as:

$${\vec{V}}_{Bp} = [ \begin{matrix}{V}_{Bp 1} \\ {V}_{Bp 2} \\ ⋮ \\ {V}_{BpN}\end{matrix} ] and {\vec{V}}_{Wp} = [ \begin{matrix}{V}_{Wp 1} \\ {V}_{Wp 2} \\ ⋮ \\ {V}_{WpN}\end{matrix} ] \qquad ( 4 )$$

wherein subscripts “B” and “W” represent black standard value and white standard value, respectively, “p” represents any one pixel in the sample image, and the black standard value and the white standard value are further stored in the data storage unit.

In an embodiment, a method for constructing N feature illuminant sources and N wavebands and acquiring reflectance value of the tested sample on N adjacent wavebands is as follows:
obtaining N luminance images of the sample by the imaging unit under the illumination of the N feature illuminant sources respectively; wherein under the illumination of the i-th illuminant source, numerical value of pixel p of the luminance image is expressed as:

$${V}_{ip} = {A}_{p} \cdot {\sum }_{j = 1}^{N} {I}_{ij} \cdot {R}_{jp} \cdot {G}_{jp} + {V}_{Bpi} , i = 1 , 2 , … , N \qquad ( 5 )$$

wherein represents a constant related to a device, Rⱼₚ represents an average reflectance of the sample at a position corresponding to the pixel p on the j-th waveband, Gⱼₚ represents an average sensitivity of the pixel p of the imaging unit on the j-th waveband, V_{Bpi} represents the black standard value of the pixel p under the i-th illuminant source (including a contribution of a surrounding environment), and Iᵢⱼ represents the average intensity of the i-th illuminant source on the j-th waveband;
taking a linear system of N×N to represent formula (5):

$${\vec{V}}_{p} = \overleftrightarrow{I} \cdot {\vec{F}}_{p} + {\vec{V}}_{B p} \qquad ( 6 )$$

wherein

$${\vec{V}}_{p} = ( \begin{matrix}{V}_{1 p} \\ {V}_{2 p} \\ ⋮ \\ {V}_{N p}\end{matrix} ) , {\vec{F}}_{p} = ( \begin{matrix}{A}_{p} {G}_{1 p} {R}_{1 p} \\ {A}_{p} {G}_{2 p} {R}_{2 p} \\ ⋮ \\ {A}_{p} {G}_{N p} {R}_{N p}\end{matrix} ) , \overleftrightarrow{I} = [ \begin{matrix}{I}_{11} & … & {I}_{1 N} \\ ⋮ & ⋱ & ⋮ \\ {I}_{N 1} & … & {I}_{NN}\end{matrix} ] \qquad ( 7 )$$

wherein formula (6) is further expressed as:

$${\vec{F}}_{p} = {\overleftrightarrow{I}}^{- 1} \cdot ( {\vec{V}}_{p} - {\vec{V}}_{B p} ) = \overleftrightarrow{J} \cdot ( {\vec{V}}_{p} - {\vec{V}}_{Bp} ) \qquad ( 8 )$$

wherein [symbol] is the illuminant characterization matrix in equation (3);
wherein formula (8) is written as:

$${A}_{p} {G}_{i p} {R}_{i p} = {\sum }_{j = 1}^{N} {J}_{i j} \cdot ( {V}_{pj} - {V}_{Bpj} ) , i = 1 , 2 , … , N \qquad ( 9 )$$

wherein in common practice, reflectance of the white standard sample is defined as one unit (i.e., “1”), the reflectance of the sample is normalized according to the reflectance of the white standard sample, and when the tested sample is the white standard sample, the reflectance at each relevant waveband are all defined as 1, and formula (9) becomes:

$${A}_{p} {G}_{ip} = {\sum }_{j = 1}^{N} {J}_{ij} \cdot ( {V}_{Wpj} - {V}_{Bpj} ) , i = 1 , 2 , … , N \qquad ( 10 )$$

wherein V_{Wpj} and V_{Bpj} are the black standard value and the white standard value of the pixel p of the multispectral image under a j-th illuminant source, and V_{Wpj} and V_{Bpj} are represented by formula (4);
by combining formula (9) and formula (10), the reflectance value of any pixel p of the multispectral image on N wavebands is represented as:

$${R}_{i p} = \frac{{\sum }_{j = 1}^{N} {J}_{ij} \cdot ( {V}_{pj} - {V}_{Bj} )}{{\sum }_{j = 1}^{N} {J}_{ij} \cdot ( {V}_{Wj} - {V}_{Bj} )} , i = 1 , 2 , … , N . \qquad ( 11 )$$

In an embodiment, dividing the predetermined range of test spectrum further adopts the following manner:
selecting N feature illuminant sources and M wavebands, using a standard least squares method when M≤N, and using a singular value matrix decomposition (SVD) method when M≥N to calculate the illuminant characterization matrix in formula (2) or formula (3), and obtaining a dimension of M×N, wherein the reflectance values in formula (11) has M components;
further, using M (M>N) feature illuminant sources and N wavebands, and adopting a main component analysis method to obtain the illuminant characterization matrix of N×N.

In an embodiment, a multispectral imaging device using the above-mentioned multispectral imaging unit is provided, which includes a power supply, a shooting box, and an imaging unit, a control/display unit, a combination of feature illuminant sources and a sample rack arranged in the shooting box;
wherein an interior of the shooting box is a shooting environment shielded from external light;
the combination of feature illuminant sources is configured to provide an illumination environment with different spectral features for the imaging unit; the sample rack is arranged at a bottom of the shooting box and is configured to place a sample test plate (reflective test) or a transmitted sample test plate (transmitted test); the imaging unit is arranged on a top of the shooting box and is arranged opposite the sample rack, and the imaging unit is configured to acquire an image with a specific format of a tested sample on the sample rack or the test plate; and
the control/display unit is electrically connected to the combination of feature illuminant sources, and is configured to control the combination of feature illuminant sources, acquire data, store data, process and calculate data, operate and display.

In an embodiment, the shooting box, the imaging unit, and the control/display unit are independently arranged or combined to constitute different devices;
the imaging unit can adopt a common monochrome (black and white) imaging unit or a colour imaging unit (when using a colour system, only brightness data generated thereby is used); and
a front of the combination of feature illuminant sources is provided with a scattering film or a scattering cap for enabling the illuminant sources to provide uniformly diffused light.

A method of using the multispectral imaging device is provided, wherein
when a multispectral reflectance image is tested, the interior of the shooting box is manufactured by using a non-transparent material, and a white matte coating is spray-coated on the interior of the shooting box to improve light scattering rate of an inner wall; and the combination of feature illuminant sources is provided in the shooting box;
when the multispectral reflectance image is tested, a workflow is as follows: 1) placing the tested sample at a specific position of the sample rack; 2) turning on one or more illuminant sources in the combination of feature illuminant sources to provide illumination, and acquiring a brightness image of the sample by the imaging unit; 3) repeating previous processes for N (N≥2) times, and using different illuminant sources each time to generate N brightness images of the sample in total; and 4) with regard to a specific colour block on the tested sample, obtaining average reflectance values of the colour block on N adjacent wavebands by means of brightness data of corresponding pixels of the colour block in N images.

In an embodiment, the method includes the following steps.
when a multispectral transmittance image is tested, a black matte coating is spray-coated on an inner wall of the shooting box to reduce light reflection on the inner wall; a backlight box hermetically connected to a bottom of the shooting box is connected to a bottom of the sample rack, and the combination of feature illuminant sources is arranged in the backlight box to provide a uniform background light for the test plate; an interior of the backlight box is further a shooting environment shielded from external light, and is manufactured by using a non-transparent material, and an inner wall of the backlight box is spray-coated with a white matt coating to enhance light scattering in the backlight box;
the backlight box is in communication with the shooting box at a position of the test plate, and light rays in the backlight box pass through a transmitted sample on the test plate and enter the shooting box;
when the multispectral transmittance image is tested, a workflow is as follows: 1) placing the test plate at a specific position of the sample rack; 2) turning on one or more illuminant sources in the combination of feature illuminant sources to illuminate the test plate from below, and acquiring a brightness image of the test plate by means of the imaging device; 3) repeating previous processes for N (N≥2) times, using different illuminant sources each time to generate N brightness images of the test plate in total; and 4) for any transmitted sample on the test plate, calculating the average transmittance value of the sample on N adjacent wavebands by using the brightness data of corresponding pixels of the sample in the N images.

The present disclosure provides the multispectral imaging integrated system and device and using method thereof, which have the following effects:

The multispectral imaging integrated system and device and using method thereof are simple in structure and easy to implement. The production cost is reduced without using traditional optical elements. Reflectance values or transmittance values of the tested sample on a series of adjacent wavebands is generated at the same time, and spectral data is complete. By adopting the calibrated illuminant sources, there is no need to test the illumination spectrum in application. The test is performed in an enclosed environment, so that a test result is not affected by the external environment. The multispectral imaging can be realized by switching illuminant sources rapidly, thereby improving the test efficiency.

The working principle of the present device differs significantly from other multispectral imaging devices in that: 1) other devices adopt filters, gratings, or prisms to obtain the multispectral images, while the present device does not use these traditional optical elements, so the cost of the present device is lower; 2) other devices generate the multispectral images under a single illuminant source; the present device generates the multispectral images under a plurality of feature illuminant sources, and the time taken for switching illuminant sources is very short; therefore, the test efficiency of the present device is relatively high; 3) other devices do not have special requirements for the illuminant sources, the present device adopts the calibrated illuminant sources and stores the calibration data of the illuminant sources in the device, so the test is not affected by the external environment; therefore, both the accuracy and precision of the present device are significantly improved.

The data generated by the present device further differs from the data of other multispectral imaging devices: 1) The spectral data obtained by other imaging devices are related to the imaging illuminant source. To obtain the reflectance or transmittance data of the tested object, these devices also need to determine the spectrum of the illuminant source. The illuminant sources used in the present device have been calibrated, and the generated reflectance or transmittance data is independent to the illuminant sources. 2) The data obtained by different filters are generally isolated values in a spectrum, and do not reflect the whole spectral feature of the tested object in the test range. The present device simultaneously generates reflectance values or transmittance values on a series of adjacent wavebands to directly reflect the overall spectral feature of the tested object within the test range.

The multispectral imaging unit and device and using method thereof provided by the present disclosure can not only be used for food safety detection, medical diagnosis and artistic identification, but also can be applied in the field of colorimetric analysis. A large number of environmental and health tests now use the principle of colorimetric analysis, and need biochemical analyzers to perform quantitative or qualitative analysis. Currently, the biochemical analyzer is used to sequentially test a single sample. Using for colorimetric analysis, the present device can test and analyze many colorimetric samples together at the same time, significantly improving the detection efficiency.

Like a biochemical analyzer, the present device measures the optical absorbance of the sample within a particular wavelength range, therefore, the present device can truly be used for both quantitative and qualitative colorimetric analysis.

### BRIEF DESCRIPTION OF DRAWINGS

FIG. 1 is a structural schematic diagram of a device for testing a multispectral reflectance image showed in embodiment 2 of the present disclosure;

FIG. 2 is a structural schematic diagram of a device for testing a multispectral transmittance image showed in embodiment 3 of the present disclosure;

FIG. 3 is the spectrum of eight LED illuminants included in a combination of feature illuminant sources in embodiment 2 of the present disclosure;

FIG. 4 shows the test samples used in embodiment 2 of the present disclosure;

FIG. 5 is the luminance images of the test samples in FIG. 4, photographed by an imaging unit under different illuminant sources in FIG. 3 according to embodiment 2 of the present disclosure; and

FIG. 6 shows the spectral reflectance curve of each color block of the test sample in FIG. 4 obtained from the images of FIG. 5 (wherein the reflectance curves of color blocks 1-10 is shown from high to low).

In drawings: 1—shooting box, 2—imaging unit, 3—control/display unit, 4—combination of feature illuminant sources, 5—sample rack, 6—test plate, 7—sample, and 8—backlight box.

### DETAILED DESCRIPTION OF THE EMBODIMENTS

In the following, the technical solutions in the embodiments of the present disclosure will be clearly and completely described with reference to the drawings in the embodiments of the present disclosure. Obviously, the described embodiments are only a part of the embodiments of the present disclosure, but not all the embodiments thereof.

In the present disclosure, unless specified or limited otherwise, terms such as “connected” and “fixed” should be used broadly, and may be, for example, fixed connections, detachable connections, or integral connections; may also be mechanical connections or electrical connections; may also be direct connections or indirect connections via intervening structures; may also be inner communications of two elements or interaction relationships between two elements. The specific meanings of the above terms in the present disclosure can be understood by those skilled in the art according to specific situations.

### Embodiment 1

A multispectral imaging unit provided in the present disclosure includes an imaging unit, a combination of feature illuminant sources, a data storage unit and a data processor. The combination of feature illuminant sources comprises N (N 2) linearly independent illumination feature illuminant sources, the spectrums of which are within a predetermined range of test spectrum, and the spectral widths are not restricted. Calibration data of the feature illuminant sources are stored in the data storage unit of the device. The imaging unit is configured to obtain a series of brightness images of a tested sample under illumination of different feature illuminant sources. The data processor and the data storage unit are configured to obtain an optical reflectance or transmittance image of the tested sample within specific wavelength range from these brightness images based on a illuminant characterization matrix and an associated algorithm.

The specific algorithm steps are as follows:
1) calibrating the feature illuminant sources; wherein the predetermined range of test spectrum is divided into M (M≥2) adjacent wavebands, and spectral features of the N (N≥2) illuminant sources are calibrated into an M×N illuminant characterization matrix stored in the data storage unit;
2) testing to obtain images of a test object; wherein in a space shielded from external light, the feature illuminant sources in step 1) are used respectively to illuminate a tested sample in an individual or combined manner, and N images of the tested sample are obtained under illumination of different illuminant sources by the imaging unit; and
3) analyzing and calculating to obtain average optical reflectance values or transmittance values at any point of the tested sample; wherein based on brightness data of N images, the average optical reflectance values or transmittance values at any point of the test object on M adjacent wavebands is obtained simultaneously by means of the illuminant characterization matrix and associated calculations, and the reflectance values or transmittance values on a series of adjacent wavebands is generated to directly reflect an overall spectral feature of the test object on a test range.

The feature illuminant sources adopt N LED illuminant sources with different central wavelengths. And spectrum of any one of the feature illuminant sources cannot be obtained by a linear combination of other illuminant sources. Spectral features of the feature illuminant sources are calibrated into the illuminant characterization matrix. The calibration method is as follows:

The predetermined range of test spectrum is divided into N adjacent wavebands, wherein each waveband occupies a range of wavelengths from λⱼ₋₁ to λⱼ j (λⱼ>λⱼ₋₁, j=1, 2, . . . , N), and the width of each waveband is not restricted.

An average intensity of the i-th illuminant source on the j-th waveband is expressed as:

$${I}_{i j} = \frac{1}{{λ}_{j} - {λ}_{j - 1}} \cdot {\int }_{{λ}_{j - 1}}^{{λ}_{j}} {I}_{i} ( λ ) d λ , i = 1 , 2 , … , N , j = 1 , 2 , … , N \qquad ( 1 )$$

wherein Iᵢ (λ) is an intensity of the i-th illuminant source at wavelength A measured by an external spectroscopic tester.

Above calculation is performed on N wavebands and N illuminant sources to form an N×N matrix [symbol] ,

$$\overleftrightarrow{I} = [ \begin{matrix}{I}_{11} & … & {I}_{1 N} \\ ⋮ & ⋱ & ⋮ \\ {I}_{N 1} & … & {I}_{NN}\end{matrix} ] \qquad ( 2 )$$

wherein the matrix [symbol] represents average intensities on N wavebands for each of the feature illuminant sources, respectively. Wherein matrix inverse calculation is performed on the matrix [symbol] to obtain an N×N matrix referred to as a illuminant characterization matrix. And wherein the illuminant characterization matrix is represented as:

$$\overleftrightarrow{J} = {\overleftrightarrow{I}}^{- 1} = [ \begin{matrix}{J}_{11} & … & {J}_{1 N} \\ ⋮ & ⋱ & ⋮ \\ {J}_{N 1} & … & {J}_{NN}\end{matrix} ] \qquad ( 3 )$$

wherein the obtained illuminant characterization matrix [symbol] is stored in the data storage unit.

Before testing the sample, brightness data of a black or standard non-transparent sample and a white or standard transparent sample are tested as reference values for calculating the reflectance values or transmittance values.

The method for acquiring black standard data and white standard data is as follows:

A black standard sample is placed at a location where the sample is placed, N images of black standard luminance are acquired under illumination of N feature illuminant sources respectively in a manner of testing a common sample. Then a white standard sample is tested in the same manner to obtain N images of white standard luminance under the illumination of N feature illuminant sources. After testing the black standard sample and white standard sample, any pixel p of a multispectral image has a black standard value and a white standard value corresponding to each feature illuminant source. The black standard value and the white standard value are represented as:

$${\vec{V}}_{B p} = [ \begin{matrix}{V}_{Bp 1} \\ {V}_{Bp 2} \\ ⋮ \\ {V}_{BpN}\end{matrix} ] and {\vec{V}}_{W p} = [ \begin{matrix}{V}_{Wp 1} \\ {V}_{Wp 2} \\ ⋮ \\ {V}_{WpN}\end{matrix} ] \qquad ( 4 )$$

wherein subscripts “B” and “W” represent black standard value and white standard value, respectively, “p” represents any one pixel in the sample image. The black standard value and the white standard value are further stored in the data storage unit.

A method for constructing N feature illuminant sources and N wavebands and acquiring reflectance values of the tested sample on N adjacent wavebands is as follows:

N luminance images of the sample are obtained by the imaging unit under the illumination of the N feature illuminant sources respectively. Under the illumination of the i-th illuminant source, numerical value of pixel p of the luminance image is expressed as:

$${V}_{ip} = {A}_{p} \cdot {\sum }_{j = 1}^{N} {I}_{ij} \cdot {R}_{jp} \cdot {G}_{jp} + {V}_{Bpi} , i = 1 , 2 , … , N \qquad ( 5 )$$

wherein represents a constant related to a device, Rⱼₚ represents an average reflectance of the sample at a position corresponding to the pixel p on the j-th waveband, Gⱼₚ represents an average sensitivity of the pixel p of the imaging unit on the j-th waveband, V_{Bpi} represents the black standard value of the pixel p under the i-th illuminant source (including a contribution of a surrounding environment), and Iᵢⱼ represents the average intensity of the i-th illuminant source on the j-th waveband.

A linear system of N×N is taken to represent formula (5):

$${\vec{V}}_{p} = \overleftrightarrow{I} \cdot {\vec{F}}_{p} + {\vec{V}}_{B p} \qquad ( 6 )$$

wherein

$${\vec{V}}_{p} = ( \begin{matrix}{V}_{1 p} \\ {V}_{2 p} \\ ⋮ \\ {V}_{Np}\end{matrix} ) , {\vec{F}}_{p} = ( \begin{matrix}{A}_{p} {G}_{1 p} {R}_{1 p} \\ {A}_{p} {G}_{2 p} {R}_{2 p} \\ ⋮ \\ {A}_{p} {G}_{Np} {R}_{Np}\end{matrix} ) , \overleftrightarrow{I} = [ \begin{matrix}{I}_{11} & … & {I}_{1 N} \\ ⋮ & ⋱ & ⋮ \\ {I}_{N 1} & … & {I}_{NN}\end{matrix} ] \qquad ( 7 )$$

wherein formula (6) is further expressed as:

$${\vec{F}}_{p} = {\overleftrightarrow{I}}^{- 1} \cdot ( {\vec{V}}_{p} - {\vec{V}}_{B p} ) = \overleftrightarrow{J} \cdot ( {\vec{V}}_{p} - {\vec{V}}_{Bp} ) \qquad ( 8 )$$

wherein [symbol] is the illuminant characterization matrix in equation (3).

Wherein formula (8) is written as:

$${A}_{p} {G}_{i p} {R}_{i p} = {\sum }_{j = 1}^{N} {J}_{i j} \cdot ( {V}_{p j} - {V}_{B p j} ) , i = 1 , 2 , … , N \qquad ( 9 )$$

wherein in common practice, reflectance of the white standard sample is defined as one unit (i.e., “1”), the reflectance of the sample is normalized according to the reflectance of the white standard sample. When the tested sample is the white standard sample, the reflectance at each relevant waveband are all defined as 1, and formula (9) becomes:

$${A}_{p} {G}_{ip} = {\sum }_{j = 1}^{N} {J}_{ij} \cdot ( {V}_{W p j} - {V}_{B p j} ) , i = 1 , 2 , … , N \qquad ( 10 )$$

wherein V_{Wpj} and V_{Bpj} are the black standard value and the white standard value of the pixel p of the multispectral image under a j-th illuminant source, and V_{Wpj} and V_{Bpj} are represented by formula (4).

By combining formula (9) and formula (10), the reflectance values of any pixel p of the multispectral image on N wavebands is represented as:

$${R}_{i p} = \frac{{\sum }_{j = 1}^{N} {J}_{ij} \cdot ( {V}_{p j} - {V}_{B j} )}{{\sum }_{j = 1}^{N} {J}_{i j} \cdot ( {V}_{W j} - {V}_{B j} )} , i = 1 , 2 , … , N . \qquad ( 11 )$$

The following method can also be used to divide the predetermined range of test spectrum.

N feature illuminant sources and M wavebands are selected. A standard least squares method is adopted when M≤N, and a singular value matrix decomposition (SVD) method is adopted when M≥N to calculate the illuminant characterization matrix in formula (2) or formula (3). A dimension of M×N will be obtained. Therefore, the reflectance values in formula (11) has M components.

Further, M (M≥N) feature illuminant sources and N wavebands can also be used. A main component analysis method is adopted to obtain the illuminant characterization matrix of N×N.

The working principle of the multispectral imaging unit provided by the present disclosure differs significantly from other multispectral imaging devices in that: 1) other devices adopt filters, gratings, or prisms to obtain the multispectral images, while the multispectral imaging unit and device thereof provided by the present disclosure does not use these traditional optical elements; 2) other devices generate the multispectral images under a single illuminant source; the present device generates the multispectral images under a plurality of feature illuminant sources; 3) other devices do not have special requirements for the illuminant sources, the present device adopts the calibrated illuminant sources and stores the calibration data of the illuminant sources in the device.

The data generated by the present device further differs from the data of other multispectral imaging devices: 1) The spectral data obtained by other imaging devices are related to the imaging light source. When the reflectance or transmittance data of the tested object is to be obtained, these devices also need to determine the spectrum of the imaging light source. The illuminant sources used in the present device have been calibrated, and the generated reflectance or transmittance data is independent to the illuminant sources. 2) The data obtained by different filters are generally isolated values in a spectrum, and do not reflect the whole spectrum feature of the tested object in the test range. The present device simultaneously generates reflectance values or transmittance values on a series of adjacent wavebands to directly reflect the overall spectral feature of the tested object within the test range.

The multispectral imaging integrated system and device and using method thereof have a simple and ingenious structure and a distinctive detection principle. The illuminant sources used in the device have been calibrated, the generated reflectance or transmittance data is independent of the light sources, the detection is not affected by the external environment, and the device is easy to operate. The detection accuracy and precision are significantly improved. The present device simultaneously generates reflectance values or transmittance values on a series of adjacent wavebands to directly reflect the overall spectral feature of the test object on the test range, and significantly improves the detection efficiency. The present device can be widely used for both quantitative and qualitative colorimetric analysis in the real sense.

### Embodiment 2

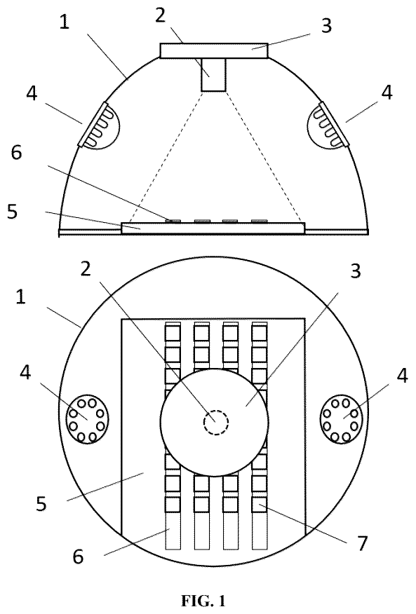

As shown in FIG. 1, the multispectral imaging device provided by the present disclosure using the above-mentioned multispectral imaging unit. When a multispectral reflectance image needs to be tested, the device includes a shooting box 1, an imaging unit 2, a control/display unit 3, a combination of feature illuminant sources 4 and a sample rack 5. The shooting box 1 provides a shooting environment shielded from external light. The shooting box 1 is manufactured by using a non-transparent material. A white matte coating is spray-coated on an interior of the shooting box 1 to improve light scattering rate of an inner wall. The imaging unit 2 and the combination of feature illuminant sources 4 are installed inside the shooting box 1. The imaging unit 2 is configured to acquire an image with a specific format (such as a JPG format image) of a sample 7.

The imaging unit 2 can adopt a common monochrome (black and white) imaging unit or a colour imaging unit (when using a colour system, only brightness data generated thereby is used). The combination of feature illuminant sources 4 is configured to provide an illumination environment with different spectral features for the imaging unit. The front of the illuminant sources is provided with a scattering film or a scattering cap for enabling the illuminant sources to provide uniformly diffused light. A sample rack 5 for placing the sample is mounted at the bottom of the shooting box 1, and the sample rack 5 can be pulled out of the shooting box 1 when the sample 7 is replaced. The control/display unit 3 completes functions such as illuminant source control, data acquisition, data storage, data processing and calculation, operation and display. This device can use batteries or an external DC power source.

A method of using the multispectral imaging device provided by the present disclosure includes the following steps.

The workflow for testing multispectral reflectance image is as follows: 1) placing the sample 7 (for example, the special shade tab) at a specific position of the sample rack 5; 2) turning on one or more illuminant sources in the combination of feature illuminant sources 4 to provide illumination, and acquiring a brightness image of the sample 7 by the imaging unit 2; 3) repeating previous processes for N (N≥2) times, and using different illuminant sources each time to generate N brightness images of the sample in total; and 4) with regard to a specific colour block on the sample 7, obtaining average reflectance values data of the colour block on N adjacent wavebands by means of brightness data of corresponding pixels of the colour block in N images.

Parameter data of the multispectral imaging device provided by the present disclosure are specifically as follows:

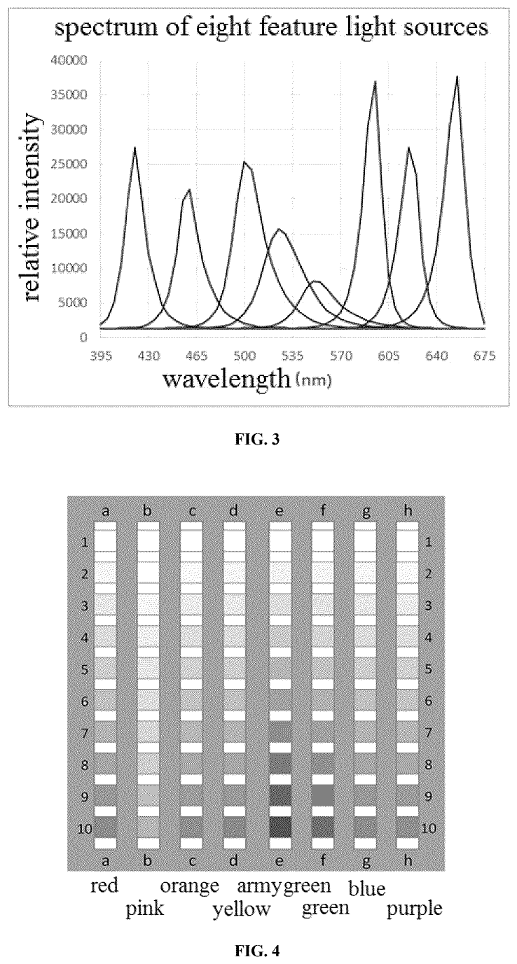

The combination of feature illuminant sources includes eight LED illuminant sources with different central wavelengths. The spectrums of these illuminant sources are shown in FIG. 3. It can be seen that the eight illuminant sources cover the spectral range of 395 nm-675 nm, and the spectral width of each illuminant source is different.

The spectral range of 395 nm-675 nm is equally divided into eight wavebands, the eight LED illuminant sources are respectively calibrated on the eight wavebands to obtain an 8×8 illuminant characterization matrix, and the illuminant characterization matrix is stored in the data storage unit of the device.

The imaging unit of the multispectral imaging device of the present disclosure adopts a multicolor digital imaging module, and an image generated thereby is in a JPG format. The device obtains brightness data from JPG data according to a conventional general method.

A black standard and a white standard are used as reference values for calculating reflectance in the multispectral imaging device of the present disclosure. As a special example, the black and white standards were made using pure black and pure white matte coatings, respectively, sprayed onto a cardboard matching the sample rack. The black and white standard values were generated as follows:
firstly, placing the black standard on the sample rack 5 in the shooting box 1, obtaining black sample luminance images under the illumination of each of the feature illuminant sources in the combination of feature illuminant sources 4 respectively, then obtaining white sample luminance images under the illumination of each of the feature illuminant sources in the combination of feature illuminant sources 4 respectively in the same manner, and storing these data as black and white calibration data in the data storage unit.

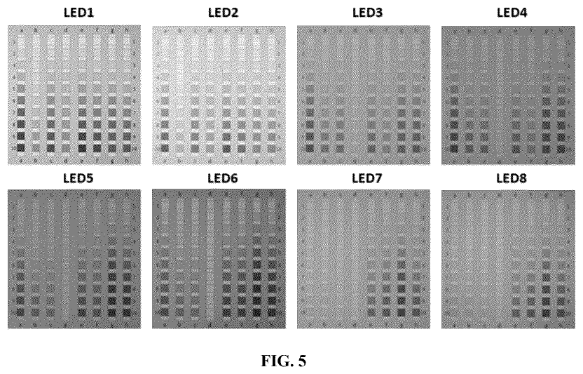

FIG. 4 shows color samples made for the test multispectral experiment device of the present disclosure, which includes eight color block series with different colors, namely: a red, b pink, c orange, d yellow, e army green, f green, g blue, and h purple. Each color block series further includes 10 color blocks from light to dark, labeled with numbers 1-10.

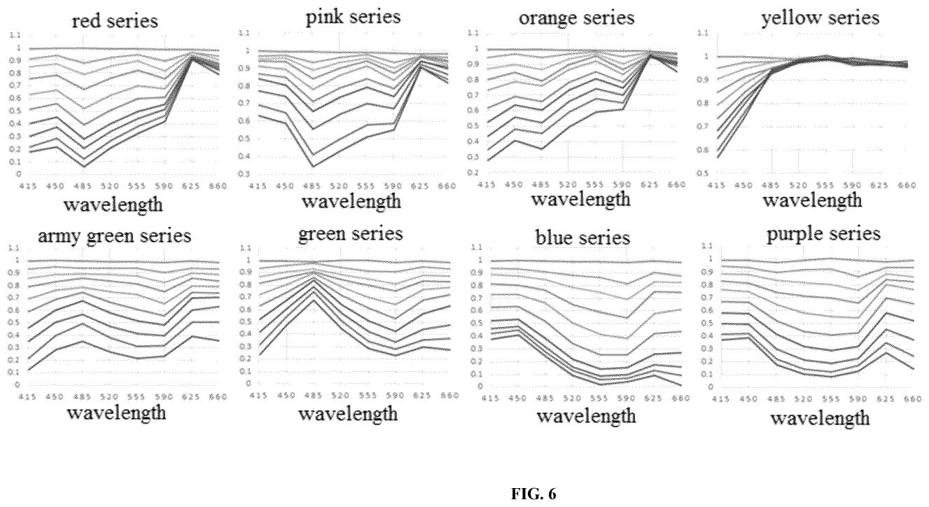

The sample 7 made in FIG. 4 is placed on the sample rack 5 in the shooting box 1. Brightness images of the eight samples are obtained under illumination of eight feature illuminant sources respectively. As shown in FIG. 5, it shows the results of further matching the brightness images obtained under illumination of eight different feature illuminant sources with the sample 7 corresponding to different illuminant sources in FIG. 3 and FIG. 4. For each color blocks on the sample 7, the test multispectral experimental device of the present disclosure uses luminance values of the sample 7 in eight images to calculate the average reflectance of each color block on eight wavebands based on the illuminant characterization matrix, black and white calibration data, and the aforementioned algorithms. The results are shown in FIG. 6, it shows spectral curves of each color block obtained in FIG. 5 corresponding the sample 7 in FIG. 4 using the test multispectral experimental device in the present disclosure. It can be clearly seen that these curves reflect the spectral features of the individual color blocks in sample 7 within the entire test range and the spectral change in reflectance values of these color blocks from light to dark. These corresponding reflectance testing data indicate that the test multispectral experimental device of the present disclosure can be used to perform a quantitative colorimetric analysis in the real sense at any point in the imaging area. Since the imaging and calculation can be completed in a very short time (e. g., within a few seconds) during the whole process, the present device can simultaneously detect a large amount of color samples, significantly improving the detection efficiency.

### Embodiment 3

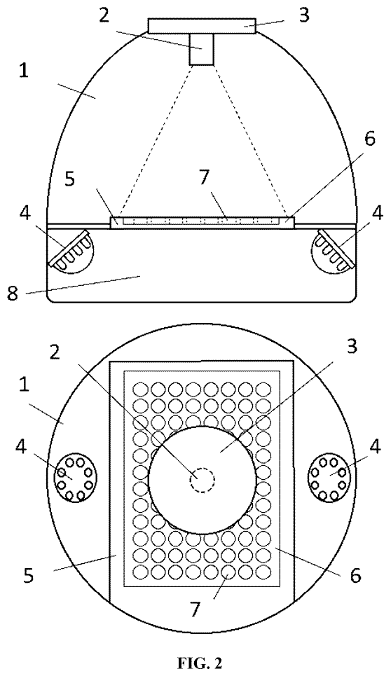

As shown in FIG. 2, in the multispectral imaging device provided by the present disclosure, when a multispectral transmittance image needs to be tested, the device includes a shooting box 1, an imaging unit 2, a control/display unit 3, a combination of feature illuminant sources 4, a sample rack 5 and a backlight box 8. The imaging unit 2, the control/display unit 3 and the combination of feature illuminant sources 4 are the same as those in embodiment 2, and the corresponding structures and effects thereof are not described one by one. The difference lies in that: the backlight box 8 hermetically connected to a bottom of the shooting box 1 is connected to a bottom of the sample rack 5, and the combination of feature illuminant sources 4 is arranged in the backlight box 8 to provide a uniform background light for the test plate 6. An interior of the backlight box 8 is further a shooting environment shielded from external light, and is manufactured by using a non-transparent material, and an inner wall of the backlight box 8 is spray-coated with a white matt coating to enhance light scattering in the backlight box 8.

A black matte coating is spray-coated on an inner wall of the shooting box 1 to reduce light reflection on the inner wall. The sample rack 5 is configured to place the test plate 6 dedicated to a transmission test. The sample rack 5 can be pulled out and pushed into the shooting box 1 according to the requirement for placing the sample. The backlight box 8 is configured to provide the uniform background light for the test plate 6. The combination of feature illuminant sources 4 is arranged in the backlight box 8. The inner wall of the backlight box 8 is spray-coated with the white matte coating so as to enhance the scattering light in the box. The shooting box 1 and the backlight box 8 are both made of non-transparent materials. The backlight box 8 is in communication with the shooting box 1 at the position of the test plate 6, and light rays in the backlight box 8 pass through the transmitted sample 7 on the test plate 6 and enter the shooting box.

A method for using the multispectral imaging device provided by the present disclosure includes the following steps.

The workflow for testing the multispectral transmittance image is: 1) placing the test plate 6 at a specific position of the sample rack 5; 2) turning on one or more illuminant sources in the combination of feature illuminant sources 4 to illuminate the test plate 6 from below, and acquiring a brightness image of the test plate 6 by means of the imaging device 2; 3) repeating previous processes for N (N≥2) times, using different illuminant sources each time to generate N brightness images of the test plate in total; and 4) for any transmitted sample 7 on the test plate, calculating the average transmittance data of the color block on N adjacent wavebands by using the brightness data of corresponding pixels of the sample in the N images.

The multispectral imaging unit and device and using method thereof provided by the present disclosure can not only be used for food safety detection, medical diagnosis and artistic identification, but also can be applied in the field of colorimetric analysis. A large number of environments and healthy detections now use the principle of colorimetric analysis, and a biochemical analyzer is required to perform quantitative or qualitative analysis. Currently, the biochemical analyzer is used to sequentially test a single sample. The present device is used for colorimetric analysis, and many colorimetric samples can be put together to be tested and analyzed at the same time, significantly improving the detection efficiency.

Like a biochemical analyzer, the present device acquires the optical absorbance of the sample within a particular wavelength range, therefore, the present device can truly be used for both quantitative and qualitative colorimetric analysis.

In conclusion, the detection mechanism of the multispectral imaging device and system of the present disclosure is significantly different from other existing mechanisms. The prominent features of the present disclosure are simple structure, low cost, easy miniaturization, and providing complete spectral data. Using calibrated illuminant sources, the spectral data acquired by the device is independent to the illuminant sources and not affected by external environment. The device simultaneously acquires reflectance values or transmittance values on a series of adjacent wavebands, presenting the overall spectral feature of the tested object within the test range. The device is easy to operate and has significantly improved accuracy and precision. With much improved detection efficiency, the device can be widely used for actual quantitative or qualitative colorimetric analysis.

The above are only embodiments of the present disclosure, and for example, the shooting box 1, the imaging unit 2, and the control/display unit 3 of the present disclosure may be independently arranged or combined to constitute different devices.

For another example, an independent imaging device and an independent shooting box can be used to generate images of the sample under a series of feature illuminant sources, and then these images are transmitted to an independent data processing unit for processing and calculation to obtain a final result. The multispectral imaging unit and device and using method thereof can all be implemented.

The above descriptions are merely the preferred embodiments of the present disclosure, but are not intended to limit the scope of the present disclosure. Any person skilled in the art can make equivalent replacements or modifications to the technical solutions of the present disclosure and the inventive concepts thereof within the technical scope disclosed in the present disclosure, and the modifications and replacements shall fall within the scope of the present disclosure.

What is claimed is:

1. A multispectral imaging unit, comprising an imaging unit, a combination of feature illuminant sources, a data storage unit, a data processing unit and a display/control unit;
wherein the combination of feature illuminant sources comprises N (N≥2) linearly independent illuminant sources within a predetermined range of test spectrum, and spectral widths of the illuminant sources are not restricted;
wherein the combination of feature illuminant sources is calibrated on a plurality of adjacent wavebands; calibrated data are stored in the data storage unit; the imaging unit is configured to generate a plurality of images of a tested sample under illumination of different feature illuminant sources; and the data processing unit and the data storage unit are configured to analyze and calculate the plurality of images of the sample based on the calibrated data and associated algorithm to obtain an optical reflectance or transmittance spectral image of the sample in a specific wavelength range.

2. The multispectral imaging unit according to claim 1, wherein the algorithm comprises:
1) calibrating the feature illuminant sources; wherein the predetermined range of test spectrum is divided into M (M≥2) adjacent wavebands, and spectral features of the N (N≥2) illuminant sources are calibrated into an M×N illuminant characterization matrix stored in the data storage unit;
2) testing to obtain images of a test object; wherein in a space shielded from external light, the feature illuminant sources in step 1) are used respectively to illuminate a tested sample in an individual or combined manner, and N images of the sample are obtained under illumination of different illuminant sources by the imaging unit; and
3) analyzing and calculating to obtain average optical reflectance values or transmittance values at any point of the tested sample; wherein based on brightness data of N images—any pixel of a sample image, the average optical reflectance values or transmittance values at any point of the test object on M adjacent wavebands is obtained simultaneously by means of the illuminant characterization matrix and associated calculations, and the reflectance values or transmittance values is generated to directly reflect an overall spectral feature of the test object on a test range.

3. The multispectral imaging unit according to claim 2, wherein the illuminant sources adopt calibrated illuminant sources, the feature illuminant sources adopt LED illuminant sources with different central wavelengths, and spectrum of any one of the feature illuminant sources cannot be obtained by a linear combination of other illuminant sources;
spectral features of the feature illuminant sources are calibrated into the illuminant characterization matrix, and the combination of illuminant sources comprises N feature illuminant sources; wherein a calibration method is as follows:
dividing the predetermined range of test spectrum into N adjacent wavebands, wherein each waveband occupies a range of wavelengths from λⱼ₋₁ to λⱼ (λⱼ>λⱼ₋₁, j=1, 2, . . . , N), and the width of each wavebands not restricted;
taking the following formula to express an average intensity of a i-th illuminant source on a j-th waveband:
$${I}_{i j} = \frac{1}{{λ}_{j} - {λ}_{j - 1}} \cdot {\int }_{{λ}_{j - 1}}^{{λ}_{j}} {I}_{i} ( λ ) d λ , i = 1 , 2 , … , N , j = 1 , 2 , … , N \qquad ( 1 )$$
wherein Iᵢ (λ) is an intensity of the i-th illuminant source at wavelength A measured by an external spectroscopic tester;
performing above calculation on N wavebands and N illuminant sources to form an N×N matrix [symbol] ,
$$\overleftrightarrow{I} = [ \begin{matrix}{I}_{11} & … & {I}_{1 N} \\ ⋮ & ⋱ & ⋮ \\ {I}_{N 1} & … & {I}_{NN}\end{matrix} ] \qquad ( 2 )$$
wherein the matrix [symbol] represents average intensities on N wavebands for each of the feature illuminant sources, respectively, wherein matrix inverse calculation is performed on the matrix [symbol] to obtain an N×N matrix referred to as a illuminant characterization matrix, and wherein the illuminant characterization matrix is represented as:
$$\overleftrightarrow{J} = {\overleftrightarrow{I}}^{- 1} = [ \begin{matrix}{J}_{11} & … & {J}_{1 N} \\ ⋮ & ⋱ & ⋮ \\ {J}_{N 1} & … & {J}_{NN}\end{matrix} ] \qquad ( 3 )$$
wherein the obtained illuminant characterization matrix [symbol] is stored in the data storage unit.

4. The multispectral imaging unit according to claim 3, wherein before testing the sample, brightness data of a black or standard non-transparent sample and a white or standard transparent sample are tested as reference values for calculating the reflectance values or transmittance values;
a method for acquiring black standard data and white standard data is as follows:
placing a black standard sample at a location where the sample is placed, acquiring N images of black standard luminance under illumination of N feature illuminant sources respectively in a manner of testing a common sample; then testing a white standard sample in a same manner to obtain N images of white standard luminance under the illumination of N feature illuminant sources; wherein after testing the black standard sample and white standard sample, any pixel p of a multispectral image has a black standard value and a white standard value corresponding to each feature illuminant source, wherein the black standard value and the white standard value are represented as:
$${\vec{V}}_{Bp} = [ \begin{matrix}{V}_{Bp 1} \\ {V}_{Bp 2} \\ ⋮ \\ {V}_{BpN}\end{matrix} ] and {\vec{V}}_{Wp} = [ \begin{matrix}{V}_{Wp 1} \\ {V}_{Wp 2} \\ ⋮ \\ {V}_{WpN}\end{matrix} ] \qquad ( 4 )$$
wherein subscripts “B” and “W” represent black standard value and white standard value, respectively, “p” represents any one pixel in the sample image, and the black standard value and the white standard value are further stored in the data storage unit.

5. The multispectral imaging unit according to claim 4, wherein a method for constructing N feature illuminant sources and N wavebands and acquiring reflectance values of the tested sample on N adjacent wavebands is as follows:
obtaining N luminance images of the sample by the imaging unit under the illumination of the N feature illuminant sources respectively; wherein under the illumination of the i-th illuminant source, numerical value of pixel p of the luminance image is expressed as:
$${V}_{ip} = {A}_{p} \cdot {\sum }_{j = 1}^{N} {I}_{ij} \cdot {R}_{jp} \cdot {G}_{jp} + {V}_{Bpi} , i = 1 , 2 , … , N \qquad ( 5 )$$
wherein represents a constant related to a device, Rⱼₚ represents an average reflectance of the sample at a position corresponding to the pixel p on the j-th waveband, Gⱼₚ represents an average sensitivity of the pixel p of the imaging unit on the j-th waveband, V_{BPi} represents the black standard value of the pixel p under the i-th illuminant source (including a contribution of a surrounding environment), and Iᵢⱼ represents the average intensity of the i-th illuminant source on the j-th waveband;
taking a linear system of N×N to represent formula (5):
$${\vec{V}}_{p} = \overleftrightarrow{I} \cdot {\vec{F}}_{p} + {\vec{V}}_{B p} \qquad ( 6 )$$
wherein
$${\vec{V}}_{p} = ( \begin{matrix}{V}_{1 p} \\ {V}_{2 p} \\ ⋮ \\ {V}_{N p}\end{matrix} ) , {\vec{F}}_{p} = ( \begin{matrix}{A}_{p} {G}_{1 p} {R}_{1 p} \\ {A}_{p} {G}_{2 p} {R}_{2 p} \\ ⋮ \\ {A}_{p} {G}_{N p} {R}_{N p}\end{matrix} ) , \overleftrightarrow{I} = [ \begin{matrix}{I}_{11} & … & {I}_{1 N} \\ ⋮ & ⋱ & ⋮ \\ {I}_{N 1} & … & {I}_{NN}\end{matrix} ] \qquad ( 7 )$$
wherein formula (6) is further expressed as:
$${\vec{F}}_{p} = {\overleftrightarrow{I}}^{- 1} \cdot ( {\vec{V}}_{p} - {\vec{V}}_{B p} ) = \overleftrightarrow{J} \cdot ( {\vec{V}}_{p} - {\vec{V}}_{B p} ) \qquad ( 8 )$$
wherein [symbol] is the illuminant characterization matrix in equation (3);
wherein formula (8) is written as:
$${A}_{p} {G}_{i p} {R}_{i p} = {\sum }_{j = 1}^{N} {J}_{i j} \cdot ( {V}_{p j} - {V}_{B p j} ) , i = 1 , 2 , … , N \qquad ( 9 )$$
wherein in common practice, reflectance of the white standard sample is defined as one unit (“1”), the reflectance of the sample is normalized according to the reflectance of the white standard sample, and when the tested sample is the white standard sample, the reflectance at each relevant waveband are all defined as 1, and formula (9) becomes:
$${A}_{p} {G}_{ip} = {\sum }_{j = 1}^{N} {J}_{ij} \cdot ( {V}_{W p j} - {V}_{B p j} ) , i = 1 , 2 , … , N \qquad ( 10 )$$
wherein V_{Wpj} and V_{Bpj} are the black standard value and the white standard value of the pixel p of the multispectral image under a j-th illuminant source, and V_{Wpi} and V_{Bpj} are represented by formula (4);
by combining formula (9) and formula (10), the reflectance values of any pixel p of the multispectral image on N wavebands is represented as:
$${R}_{i p} = \frac{{\sum }_{j = 1}^{N} {J}_{ij} \cdot ( {V}_{p j} - {V}_{B j} )}{{\sum }_{j = 1}^{N} {J}_{i j} \cdot ( {V}_{W j} - {V}_{B j} )} , i = 1 , 2 , … , N . \qquad ( 11 )$$

6. The multispectral imaging unit according to claim 5, wherein dividing the predetermined range of test spectrum further adopts the following manner:
selecting N feature illuminant sources and M wavebands, using a standard least squares method when M≤N, and using a singular value matrix decomposition (SVD) method when M≥N to calculate the illuminant characterization matrix in formula (2) or formula (3), and obtaining a dimension of M×N, wherein the reflectance values in formula (11) has M components;
further, using M (M≥N) feature illuminant sources and N wavebands, and adopting a main component analysis method to obtain the illuminant characterization matrix of N×N.

7. A multispectral imaging device using the multispectral imaging unit as claimed in claim 1, comprising a power supply, a shooting box, and an imaging unit, a control/display unit, a combination of feature illuminant sources and a sample rack arranged in the shooting box;
wherein an interior of the shooting box is a shooting environment shielded from external light;
the combination of feature illuminant sources is configured to provide an illumination environment with different spectral features for the imaging unit; the sample rack is arranged at a bottom of the shooting box and is configured to place a reflective sample test plate or a transmitted sample test plate; the imaging unit is arranged on a top of the shooting box and is arranged opposite the sample rack, and the imaging unit is configured to acquire an image with a specific format of a tested sample on the sample rack or the test plate; and
the control/display unit is electrically connected to the combination of feature illuminant sources, and is configured to control the combination of feature illuminant sources, acquire data, store data, process and calculate data, operate and display.

8. The multispectral imaging device according to claim 7, wherein the imaging unit, the combination of feature illuminant sources, a data storage unit, a data processing unit and the control/display unit are independently arranged or combined to constitute different devices;
the imaging unit adopts a common monochrome (black and white) imaging unit or a colour imaging unit (when using a colour system, only brightness data generated thereby is used); and
a front of the combination of feature illuminant sources is provided with a scattering film or a scattering cap for enabling the illuminant sources to provide uniformly diffused light.

9. A method of using the multispectral imaging device according to claim 8, wherein
when a multispectral reflectance image is tested, the interior of the shooting box is manufactured by using a non-transparent material, and a white matte coating is spray-coated on the interior of the shooting box to improve light scattering rate of an inner wall; and the combination of feature illuminant sources is provided in the shooting box;
when the multispectral reflectance image is tested, a workflow is as follows: 1) placing the tested sample at a specific position of the sample rack; 2) turning on one or more illuminant sources in the combination of feature illuminant sources to provide illumination, and acquiring a brightness image of the sample by the imaging unit; 3) repeating previous processes for N (N≥2) times, and using different illuminant sources each time to generate N brightness images of the sample in total; and 4) with regard to a specific colour block on the tested sample, obtaining average reflectance values data of the colour block on N adjacent wavebands by means of brightness data of corresponding pixels of the colour block in N images.

10. A method of using a multispectral imaging device according to claim 8, wherein
when a multispectral transmittance image is tested, a black matte coating is spray-coated on an inner wall of the shooting box to reduce light reflection on the inner wall; a backlight box hermetically connected to a bottom of the shooting box is connected to a bottom of the sample rack, and the combination of feature illuminant sources is arranged in the backlight box to provide a uniform background light for the test plate; an interior of the backlight box is further a shooting environment shielded from external light, and is manufactured by using a non-transparent material, and an inner wall of the backlight box is spray-coated with a white matt coating to enhance light scattering in the backlight box; the backlight box is in communication with the shooting box at a position of the test plate, and light rays in the backlight box pass through a transmitted sample on the test plate and enter the shooting box;
when the multispectral transmittance image is tested, a workflow is as follows: 1) placing the test plate at a specific position of the sample rack; 2) turning on one or more illuminant sources in the combination of feature illuminant sources to illuminate the test plate from below, and acquiring a brightness image of the test plate by means of the imaging device; 3) repeating previous processes for N (N≥2) times, using different illuminant sources each time to generate N brightness images of the test plate in total; and 4) for any transmitted sample on the test plate, calculating the average transmittance data of the sample on N adjacent wavebands by using the brightness data of corresponding pixels of the sample in the N images.
